(19) United States
(12) Patent Application Publication
(10) Pub. No.: US 2009/0165926 A1
(43) Pub. Date: Jul. 2, 2009

(54) Method and assembly for bonding metal layers in a gas turbine engine using a polyimide adhesive

(75) Inventors: Daniel M. Stadtlander, West Hartford, CT (US); William F. Bogue, Hebron, CT (US); Charles R. Watson, Windsor, CT (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: United Technologies Corporation, Hartford, CT (US)

(21) Appl. No.: 11/977,283

(22) Filed: Oct. 24, 2007

(51) Int. Cl. B29C 73/04; B29C 65/02

(52) U.S. Cl. 156/94; 156/499; 156/331.1

(57) ABSTRACT

A method and system is described herein for using a polyimide adhesive to bond a first metal layer to a second metal layer used in a gas turbine engine. The polyimide adhesive may be a film or a paste and is able to withstand operating temperatures in excess of 600 degrees Fahrenheit (315 degrees Celsius). In an exemplary embodiment, the second metal layer is an outer face skin of an exhaust nozzle and the first metal layer is a metal doubler configured to cover a damaged portion of the outer face skin. In some embodiments, the first and second metal layers may be formed of titanium.

### BACKGROUND

The present invention relates to bonding two metal layers used in a gas turbine engine using a high temperature adhesive. More particularly, the present invention relates to repairing a thin metal face skin of a gas turbine engine part using a metal doubler and a polyimide adhesive.

Thin metal layers, such as a titanium foil, may be used as an outer face skin on a part of a gas turbine engine. In some cases, the face skin is attached to a honeycomb core structure. The engine part typically is exposed to high operating temperatures. The outer face skin may become ripped or damaged during operation. In some cases, another part that contacts the face skin may wear through or cut through the face skin. In cases in which the part is not enclosed within a nacelle of the engine, the part may become damaged by other objects during operation or non-operational periods, for example when the engine is in service.

In order to restore the structural integrity of the engine part, a damaged face skin requires repair. A damaged metal layer may commonly be repaired through riveting or welding of a replacement metal piece over the damaged region. However, in some cases, the face skin may be too thin to rivet another metal layer to it. Welding also has limitations, especially when titanium parts are involved, which may include a long repair time, complexity and high costs. Alternatively, a replacement metal piece may be bonded to the face skin in an area covering the damaged region. However, adhesives commonly used for bonding metals are not stable at the operating temperatures in many areas of the gas turbine engine.

There is a need for an efficient method and system to repair a damaged face skin of a high temperature part of the gas turbine engine.

### SUMMARY

The present invention relates to a method and system for using a polyimide adhesive to bond a first metal layer to a second metal layer used in a gas turbine engine. The polyimide adhesive may be a film or a paste, and is able to withstand operating temperatures above 600 degrees Fahrenheit (315 degrees Celsius). In an exemplary embodiment, the second metal layer is an outer face skin of an exhaust nozzle and the first metal layer is a metal doubler configured to cover a damaged portion of the outer face skin. In some embodiments, the first and second metal layers may be formed from titanium.

### BRIEF DESCRIPTION OF THE DRAWINGS

FIG. 1 is a schematic of a gas turbine engine (with an exhaust nozzle), a pylon, and a pylon fairing connecting the engine to the pylon.

FIG. 2 is an exploded perspective view of the pylon fairing shown in FIG. 1.

FIG. 3 is an exploded perspective view of the exhaust nozzle shown in FIG. 1, including an outer face skin, and rub strips attached to the face skin.

FIG. 4 is a perspective view of a portion of the exhaust nozzle of FIG. 3, including the outer face skin, a honeycomb core, and an inner face skin.

FIG. 5 is a perspective view of a portion of the pylon fairing of FIG. 2 attached to the exhaust nozzle using the rub strips on the exhaust nozzle.

FIG. 6 is an exploded view of a portion of the exhaust nozzle and rub strips after the pylon fairing has been removed to illustrate wear through the rub strip and the outer face skin.

FIG. 7 is a perspective view of the portion of the exhaust nozzle of FIG. 6 after the damaged rub strip has been removed, and a metal doubler and an adhesive layer are positioned over the damaged portion of the outer face skin.

### DETAILED DESCRIPTION

A system and method is described herein for bonding a first metal layer and a second metal layer using a high temperature adhesive. The metal layers are a component of a gas turbine engine part. Thus, the metals are exposed to high operating temperatures and many of the commonly used adhesives are not thermally stable at these temperatures. However, polyimide is well-suited as an adhesive due to its high temperature stability and oxidative resistance. In an exemplary embodiment, the first metal layer is an outer face skin that is attached to a honeycomb core, and the second metal layer is a metal doubler or patch that is configured to cover a damaged portion of the outer face skin.

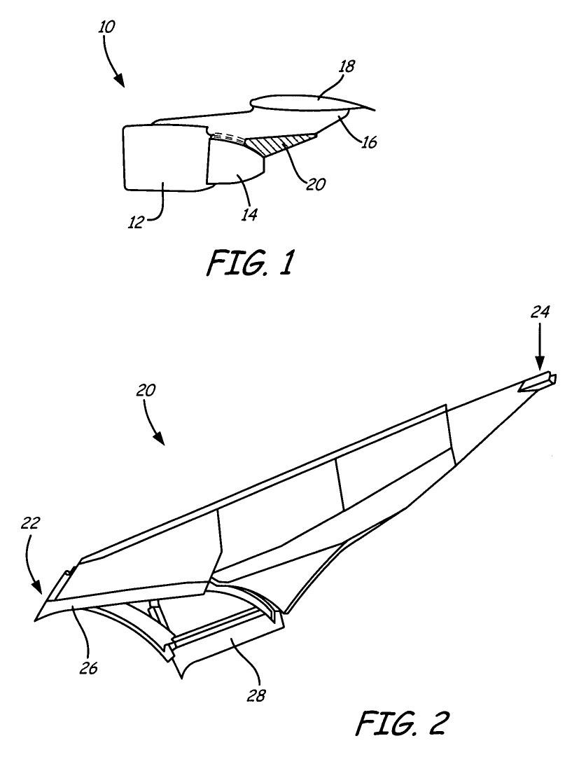

FIG. 1 is a schematic of a portion of aircraft 10 including nacelle 12, exhaust nozzle 14, pylon 16, wing 18 and pylon fairing 20. Nacelle 12 is designed to enclose a majority of a gas turbine engine, except for exhaust nozzle 14 which extends out from nacelle 12. Pylon 16 is suspended from wing 18 of aircraft 10 and is used to secure nacelle 12 to wing 18.

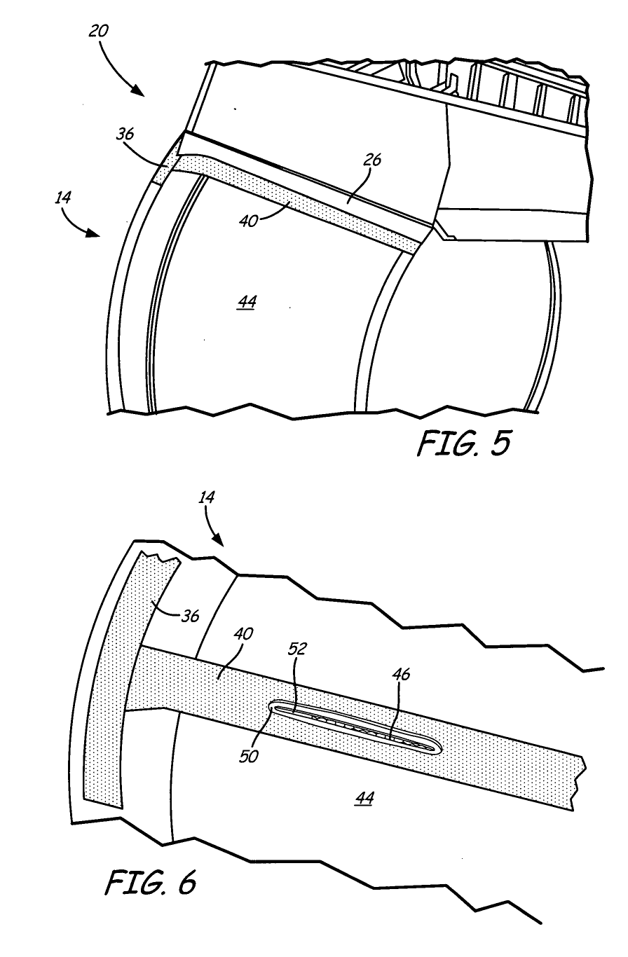

FIG. 2 is a schematic of pylon fairing 20 of FIG. 1, which is designed as an aerodynamic fairing and attached to an underside of a portion of pylon 16. Pylon fairing 20 includes forward portion 22 and aft portion 24. Fairing 20 includes first blade seal 26 and second blade seal 28, both located in forward portion 22 and configured to attach to exhaust nozzle 14 (see FIG. 5), as described below. In addition to its aerodynamic functionality, fairing 20 also acts as an insulator to prevent excessive heat exposure from exhaust nozzle 14 to pylon 16 and wing 18.

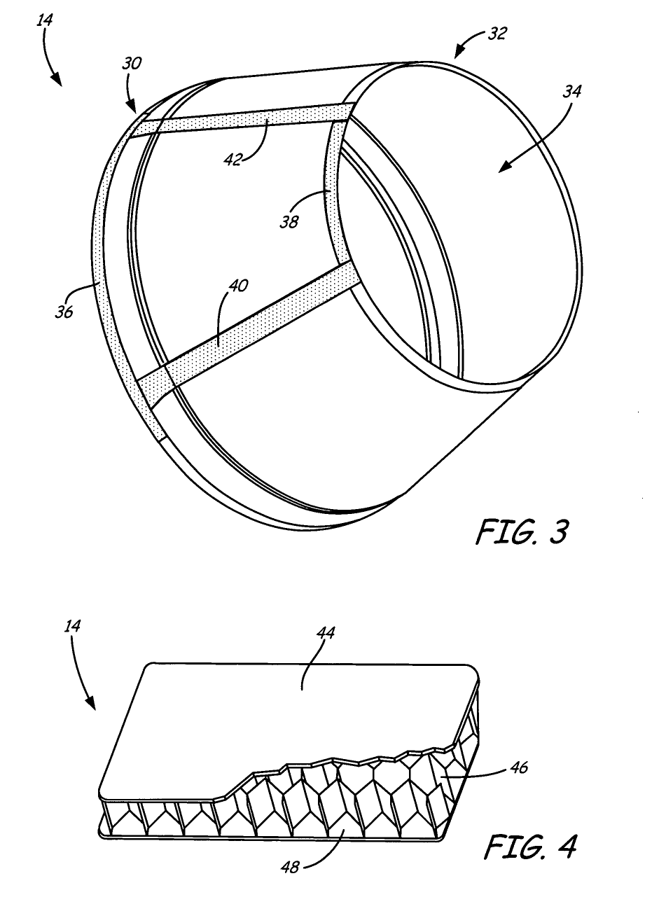

FIG. 3 is a schematic of exhaust nozzle 14 of FIG. 1, which is located at an aft end of the gas turbine engine and configured to receive hot air after the air passes through turbines of the engine. Exhaust nozzle 14 includes forward portion 30 and aft potion 32 and is designed such that opening 34 in aft portion 32 is smaller than an opening at forward portion 30. This configuration causes the hot air to accelerate as it passes through exhaust nozzle 14, which contributes in part to driving the turbine engine.

Exhaust nozzle 14 includes a pair of rub strips 36 and 38 arranged circumferentially on nozzle 14, and a pair of rub strips 40 and 42 arranged radially on nozzle 14. Circumferential rub strip 36 is located at an end of forward portion 30 and circumferential rub strip 38 is located at an end of aft portion 32. Rub strips 40 and 42 extend between rub strips 36 and 38. In some embodiments, rub strips 36, 38, 40 and 42 may be formed from metal, such as sheet metal or titanium. In some cases, rub strips 36, 38, 40 and 42 may be a sacrificial layer of exhaust nozzle 14, and may be attached to exhaust nozzle 14 using any known attachment method, including riveting.

FIG. 4 is a perspective view of a portion of exhaust nozzle 14 to illustrate the components used to form nozzle 14. An outermost layer of exhaust nozzle 14 is outer metal face skin 44 which is attached to honeycomb core 46. An innermost layer of exhaust nozzle 14 is inner metal face skin 48. A portion of outer metal face skin 44 is removed in FIG. 4 to better illustrate a structure of honeycomb core 46. In an exemplary embodiment, face skins 44 and 48 and honeycomb core 46 are titanium, and honeycomb core 46 is fusion welded to face skins 44 and 48. One or more of face skins 44 and 48, as well as core 46, may be formed from materials other than titanium. Moreover, honeycomb core 46 may be attached to face skins 44 and 48 through other known attachment methods.

In an exemplary embodiment, outer face skin 44 has a thickness ranging between approximately 10 and 20 mils (0.25 and 0.51 millimeters), and preferably between approximately 12 and 18 mils (0.30 and 0.46 millimeters). Since face skin 44 is thin, face skin 44 may also be described as a metal foil.

FIG. 5 is a schematic of pylon fairing 20 attached to exhaust nozzle 14 (also shown in FIG. 1). First blade seal 26 is shown attached to radial rub strip 40. Although not visible in FIG. 5, second blade seal 28 is attached to radial rub strip 42. First and second blade seals 26 and 28 are designed to prevent hot air from entering pylon fairing 20. In some embodiments, blade seals 26 and 28 may be formed of metal. In that case, it is not uncommon for blade seals 26 and 28, over time, to wear through rub strips 40 and 42, respectively, and to then wear through outer face skin 44 located under rub strips 40 and 42. Damage to face skin 44 may impact structural integrity of exhaust nozzle 14 and therefore requires repair.

FIG. 6 shows a portion of exhaust nozzle 14 and rub strips 36 and 40, after blade seal 26 has been removed from exhaust nozzle 14. As shown in FIG. 6, rub strip 40 and outer face skin 44 have both been damaged or worn through such that honeycomb core 46 of exhaust nozzle 14 is exposed. In this exemplary embodiment, the damage to rub strip 40 and face skin 44 was caused by blade seal 26. (Similar damage caused by blade 28 may occur on rub strip 42 and underlying face skin 44.) Due to blade seal 26 wearing through rub strip 40 and face skin 44, rub strip 40 has damaged portion 50 and face skin 44 has damaged portion 52.

As known in the art, when a portion of a metal layer of a part is damaged, repair methods may include removing the metal around the damaged area and welding a replacement metal piece, or riveting a metal patch over the damaged area.

In the case of exhaust nozzle 14, a welding repair of outer face skin 44 typically involves a complex repair process, which may require a significant amount of time (ranging from several days to several weeks) and significant costs. In some cases, the welding repair may require exhaust nozzle 14 to be detached from the gas turbine engine. Moreover, in the exemplary embodiment described herein in which skins 42 and 44 and honeycomb core 46 are titanium, alpha case may form on the surface when the titanium is exposed to high temperatures in air. Alpha case refers to oxygen-enriched titanium alpha phase, which is very brittle. Cracks in the alpha phase may propagate into the titanium, resulting in a classic cause of failure in titanium parts. Welding and stress relief may cause alpha case formation from the inside of the honeycomb chambers where the surfaces are normally inaccessible. Before welding is feasible, removal of alpha case on the surface is required, which adds significant cost and complexity to the repair process. For the above reasons, welding is not a practical repair method for damaged face skin 44 of FIG. 6. Additionally, during welding, alpha case and many other common contaminants are readily dissolved into the molten weld metal, resulting in a brittle or weak weld joint.

Riveting, specifically blind riveting, has been used for repairing a metal layer attached to a honeycomb core structure. A metal patch or doubler may be riveted over the damaged area of the metal layer. However, due to a thinness of outer face skin 44, the blind rivets may pull through too readily. Moreover, the rivets create high stress concentrations. Riveting is generally an unfavorable option for repair of damaged face skin 44.

In other applications, a metal patch or doubler has been attached to a damaged metal layer using adhesives, such as, for example, epoxy. However, in exhaust nozzle 14 and other areas of the gas turbine engine, operating temperatures may be between 500 and 600 degrees Fahrenheit (260 and 315 degrees Celsius), or greater. The majority of adhesives known in the art that are designed to bond metal layers are not stable at these high temperatures.

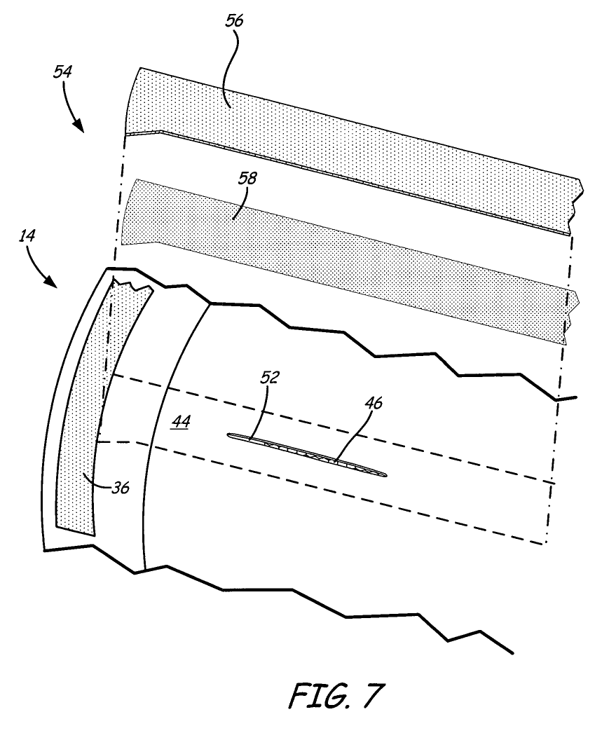

FIG. 7 illustrates a method and system that overcomes the shortcomings described above for other repair methods. FIG. 7 shows the portion of exhaust nozzle 14 shown in FIG. 6 after damaged rub strip 40 has been removed from exhaust nozzle 14. As shown in FIG. 7, exhaust nozzle 14 includes face skin 44 with damaged portion 52, which results in exposure of honeycomb core 46. Repair assembly 54 is also shown in FIG. 7, and includes metal doubler 56 and polyimide adhesive layer 58.

Doubler 56 is a piece of metal that is designed to be bonded to face skin 44 and cover damaged portion 52. In a preferred embodiment, doubler 56 is formed from the same material as face skin 44. However, in other embodiments, doubler 56 may be formed from a different metal than face skin 44. Doubler 56 has a thickness approximately equal to the thickness of face skin 44. Doubler 56 is bonded to outer face skin 44 using adhesive layer 58, which also transfers structural load between doubler 56 and skin 44.

Polyimide adhesives are well-suited for bonding doubler 56 to face skin 44. Polyimide is able to resist wear and withstand the high operating temperatures of exhaust nozzle 14. Both addition-formed polyimides and condensation polyimides may be used for adhesive layer 58. In some cases, the condensation polyimides may have a higher thermal oxidative stability, as compared to the addition polyimides.

Polyimide adhesive layer 58 may be a film adhesive or a paste adhesive, both of which are described further below. In order to transfer load between doubler 56 and outer face skin 44, it is preferred that adhesive layer 58 have a minimal thickness. A suitable thickness range for adhesive layer 58 is between approximately 3 and 25 mils (0.08 and 0.64 millimeters); a preferred range is between approximately 3 and 15 mils (0.08 and 0.38 millimeters).

In some embodiments, adhesive layer 58 is applied first to an underside of doubler 56 and then adhesive layer 58 and doubler 56 are attached to face skin 44. In other embodiments, adhesive layer 58 is first attached to face skin 44 and then doubler 56 is attached to adhesive layer 58. In both cases, adhesive layer 58 is then cured in order to bond doubler 56 and skin 44.

In some embodiments, polyimide adhesive layer 58 is a film adhesive. One example of a suitable polyimide film adhesive is FM 680 from Cytec Industries, which is stable at temperatures up to approximately 650 degrees Fahrenheit (343 degrees Celsius). FM 680 is derived from the Avimid-N family from Cytec Industries and is a condensation polyimide with high thermal oxidative stability. For applications in which the operating temperature of the engine part is less than approximately 550 degrees Fahrenheit (288 degrees Celsius), another suitable polyimide film adhesive is FM 57 from Cytec Industries, which is a condensation polyimide derived from the Avimid-R family from Cytec Industries. FM 57 is stable at temperatures up to approximately 450 to 550 degrees Fahrenheit (232 to 288 degrees Celsius).

In applying a thin adhesive layer, it may be difficult to ensure a uniform thickness. An advantage of using film adhesive 72 is an ability to better control the cured thickness of the adhesive, particularly if adhesive layer 58 is a supported film adhesive. Supports for a polyimide film adhesive may include a scrim support made, for example, of fiberglass, which is also able to withstand high operating temperatures. The support aids in processing of the film and in controlling an adhesive thickness.

Another advantage of using a film adhesive for polyimide adhesive layer 58 is that the film adhesive may be attached to an underside of doubler 56 prior to performing the repair of face skin 44. Adhesive layer 58 may be partially cured after attachment to doubler 56 and then repair assembly 54 may be frozen until needed, whereas a paste adhesive is typically prepared just prior to attaching doubler 56 to skin 44.

In some embodiments, polyimide adhesive layer 58 is a paste adhesive. Suitable polyimide adhesive pastes include but are not limited to MVK-19, AFR-PE-4 and BIM from Maverick Corporation. An advantage of using a paste adhesive is an ability to control surface contours of exhaust nozzle 14 when attaching doubler 56 to skin 44. Another advantage is that an adhesive batch size may be smaller, as compared to film adhesives. In some cases, when a paste adhesive is used, the thickness of adhesive layer 58 may be greater in some areas to adapt to the surface. As described above for film adhesives, the paste adhesive for adhesive layer 58 may include a scrim support or other support mechanism.

In a preferred embodiment, and as shown in FIG. 7, doubler 56 is sized to cover generally a full length of exhaust nozzle 14. More specifically, doubler 56 covers a full length of blade seal 26, even though damaged portion 52 of face skin 44 was confined to a smaller portion than the full length of seal 26. Doubler 56 is sized to approximately the same size as blade seal 26 to provide continuity across exhaust nozzle 14 when a replacement rub strip and blade seal 26 are reattached to nozzle 14.

Damage to outer face skin 44 may occur on other areas of exhaust nozzle 14 and be unrelated to either of blade seals 26 and 28. For example, during operation or during service, exposed portions of outer face skin 44 may be punctured. In that case, the same method and system described herein may be used to repair face skin 44. In some cases a doubler that is smaller in size than doubler 56 may be used, and the doubler may be sized to essentially cover only the damaged area of skin 44.

The repair of a thin metal face skin using a polyimide adhesive is described herein in the context of an exhaust nozzle having a titanium face skin attached to a titanium honeycomb core. The system and method described herein of using a polyimide adhesive to bond two metal layers may apply to other high-temperature engine parts, including those which do not have a honeycomb core. Moreover, it is recognized that one or both of the metal layers may include a metal that is not titanium.

Although the present invention has been described with reference to preferred embodiments, workers skilled in the art will recognize that changes may be made in form and detail without departing from the spirit and scope of the invention.

1. A method of bonding two metal layers used in a gas turbine engine, the method comprising:
applying a polyimide adhesive to a first metal layer configured to be used in a gas turbine engine;
applying the polyimide adhesive to a second metal layer configured to be used in the gas turbine engine such that the polyimide adhesive is sandwiched between the first metal layer and the second metal layer; and
curing the polyimide adhesive to bond the first metal layer and the second metal layer.

2. The method of claim 1 wherein at least one of the first metal layer and the second metal layer is titanium.

3. The method of claim 1 wherein the second metal layer is a face skin having a damaged area.

4. The method of claim 1 wherein a thickness of the first metal layer is between approximately 0.25 and 0.51 millimeters.

5. The method of claim 1 wherein the polyimide adhesive is selected from a group consisting of a film and a paste.

6. A repair assembly for repairing a metal part used in a high temperature region of a gas turbine engine, the repair assembly comprising:
a metal doubler configured to cover a damaged area of the metal part; and
a polyimide adhesive configured to attach the metal doubler to the metal part.

7. The repair assembly of claim 6 further comprising a curing device to bond the metal doubler to the metal part.

8. The repair assembly of claim 6 wherein the polyimide adhesive is selected from a group consisting of a film and a paste.

9. The repair assembly of claim 6 wherein the metal doubler is titanium.

10. The repair assembly of claim 6 wherein the metal doubler has a thickness between approximately 0.25 and 0.51 millimeters.

11. The repair assembly of claim 6 wherein the part is exposed to temperatures equal to or greater than about 315 degrees Celsius.

12. The repair assembly of claim 6 wherein the metal part is an exhaust nozzle formed from a honeycomb structure and a face sheet, and the damaged area includes a tear in the face sheet.

13. The repair assembly of claim 12 wherein the face sheet has a thickness between approximately 0.25 and 0.51 millimeters.

14. The repair assembly of claim 6 wherein the polyimide adhesive has a thickness between approximately 0.08 and 0.38 millimeters.

15. A method of repairing a part used in a gas turbine engine and having a damaged metal face skin, the method comprising:
preparing a metal foil configured to cover a damaged area of the metal face skin of the gas turbine engine part;
attaching the metal foil to the damaged area of the metal face skin using a polyimide adhesive; and
curing the polyimide adhesive to bond the metal foil to the metal face skin.

16. The method of claim 15 wherein the polyimide adhesive is a film and preparing the metal foil includes attaching the polyimide adhesive to the metal foil.

17. The method of claim 16 wherein preparing the metal foil includes freezing the metal foil after attaching the polyimide adhesive to the metal foil and prior to attaching the metal foil to the metal face skin.

18. The method of claim 15 wherein the polyimide adhesive includes at least one of a film and a paste.

19. The method of claim 15 wherein the gas turbine engine part is an exhaust nozzle.

20. The method of claim 15 wherein the gas turbine engine part operates at temperatures greater than or equal to 315 degrees Celsius.
